(19) United States
(12) Patent Application Publication
(10) Pub. No.: US 2003/0134530 A1
(43) Pub. Date: Jul. 17, 2003

(54) Terminal leg on connector for soldering purpose

(76) Inventor: Yen Yu-Feng, San Chung City (TW)

Correspondence Address: LAW OFFICE OF LIAUH & ASSOC., 4224 WAIALAE AVE, STE 5-388, HONOLULU, HI, 96816

(21) Appl. No.: 10/047,889

(22) Filed: Jan. 13, 2002

(51) Int. Cl. H01R 12/00

(52) U.S. Cl. 439/83

(57) ABSTRACT

A terminal leg on connector for soldering purpose is characterized in an outmost end on which at least one downward and outward inclined slope or at least one groove is formed. When the terminal leg is connected to a circuit board through soldering, solder applied onto the inclined or grooved outmost end of the terminal leg tends to climb up the slope or flow into the groove and generates a downward compression force to prevent the terminal leg from moving upward and separating from the applied solder. The terminal leg can therefore be firmly connected to the circuit board to ensure good electric performance thereof.

### BACKGROUND OF THE INVENTION

The present invention relates to a terminal leg on connector for soldering purpose, and more particularly to a terminal leg on connector that has an outmost end being shaped to ensure good attachment of solder thereto, so that the terminal leg can be firmly connected to a circuit board.

There are a lot of electronic components soldered onto a circuit board to form a desired electric circuitry. Among these electronic components, there are connectors having a plurality of terminals. These connectors must be as small as possible in volume to enable the design of a thin, compact, and light circuit board. The smaller a connector is, the smaller the terminals on the connector are. Legs of the terminals and spaces among these legs become extremely small, too. Thus, it is very important to solder these terminal legs with care to avoid overflowed solder that reaches neighboring terminal legs and/or circuits to cause short circuit. Meanwhile, an adequate amount of solder is required to solder these terminal legs without causing overflowing of solder.

FIG. 1 shows a conventional terminal 10 on a connector.

The terminal 10 has a leg 11 for connecting to a circuit board 14 (see FIG. 3) with solder. Currently, the terminal leg 11 may be so small that it has a ratio of width to height of 1:1. The terminal leg 11 has an end surface 12 perpendicular to the circuit board 14. When soldering the terminal leg 11 to the circuit board 14, solder 13 is in contact with the vertical end surface 12, as shown in FIGS. 2 and 3. While the solder 13 is welded to a tin liner 15 on the circuit board 14, it is not really welded to the terminal leg 11. That is, the terminal leg 11 tends to move upward and separate from the solder 13 and results in poor contact of the terminal 10 to the circuit board 14 that would have adverse influence on the electric performance of the circuit board 14. It is therefore a most common work in repairing and maintaining electric apparatus and/or computers to check all the terminal legs 11 on the connectors and re-solder any terminal leg 11 that has separated from the solder 13.

### SUMMARY OF THE INVENTION

A primary object of the present invention is to provide a terminal leg on connector that ensures good attachment of solder thereto to prevent an outer end of the terminal leg from moving upward and separating from the solder, so that a good electric performance of the connector can be assured.

To achieve the above and other objects, the terminal leg according to the present invention includes an outmost end having at least one slope formed thereat. The slope inclines downward and outward such that a bottom face of the terminal leg forms an outmost perimeter of the terminal leg. When the outmost end of the terminal leg is connected to the circuit board with solder, the solder climbs up the slope and generates a downward compression force on the slope to prevent the terminal leg from moving upward and separating from the solder.

In another embodiment of the present invention, the terminal leg includes an outmost end having at least one groove formed thereat. When the outmost end of the terminal leg is connected to the circuit board with solder, the solder flows into the groove to prevent the terminal leg from moving upward and separating from the solder. The groove may be formed at two sidewalls or an end surface of the outmost end of the terminal leg.

In the case of forming at least one slope on the outmost end of the terminal leg, the slope may have a straight top surface, a concave curved top surface, a serrated top surface, or a stepped top surface. In either case, the solder tends to firmly grip the terminal leg at its slope and hold down the terminal leg.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary perspective view of a conventional terminal leg on a connector;

FIG. 2 shows the terminal leg of FIG. 1 after being soldered onto a circuit board;

FIG. 3 is a side view of FIG. 2;

FIG. 4 is a fragmentary perspective view of a terminal leg on a connector for soldering purpose according to a first embodiment of the present invention;

FIG. 5 shows the terminal leg of FIG. 4 after being soldered onto a circuit board;

FIG. 6 is a side view of FIG. 5;

FIG. 7 is a fragmentary side view of a terminal leg on a connector for soldering purpose according to a second embodiment of the present invention;

FIG. 8 is a fragmentary side view of a terminal leg on a connector for soldering purpose according to a third embodiment of the present invention;

FIG. 9 is a fragmentary side view of a terminal leg on a connector for soldering purpose according to a fourth embodiment of the present invention;

FIG. 10 is a fragmentary side view of a terminal leg on a connector for soldering purpose according to a fifth embodiment of the present invention; and

FIG. 11 is a fragmentary side view of a terminal leg on a connector for soldering purpose according to a sixth embodiment of the present invention.

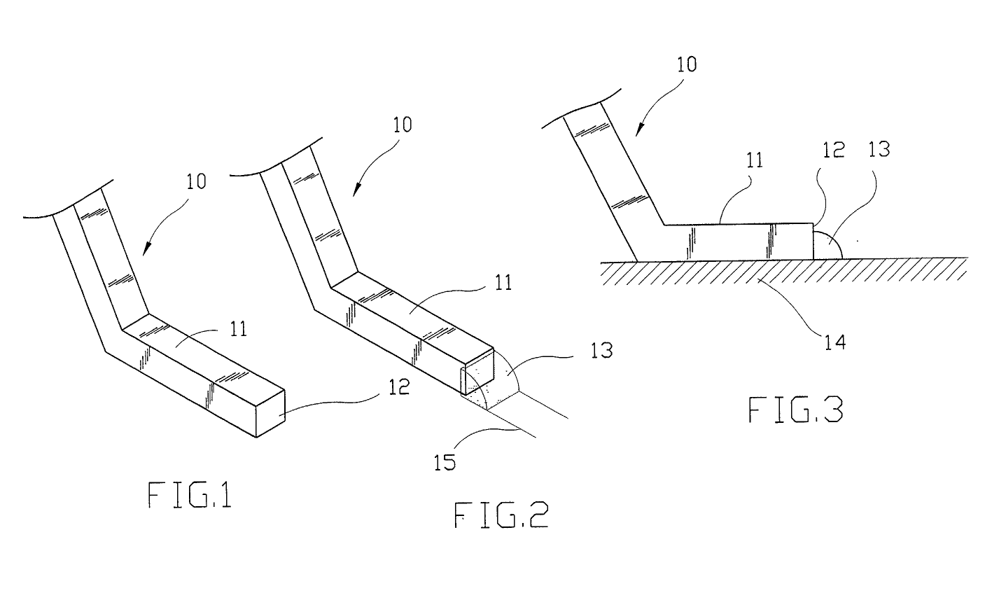

### DETAILED DESCRIPTION OF THE PREFERRED EMBODIMENTS

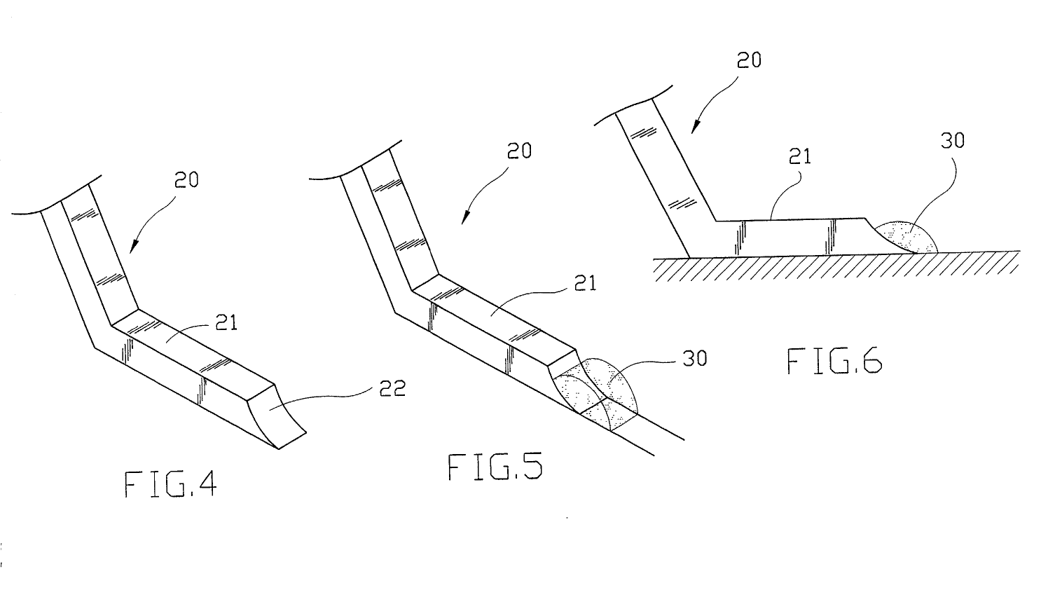

Please refer to FIG. 4 that is a fragmentary perspective view of a terminal 20 on a connector having a leg 21 for soldering purpose. According to a first embodiment of the present invention, the terminal leg 21 has an end surface at its outmost end that forms a downward and outward inclined slope 22, so that a bottom face of the terminal leg 21 forms an outmost perimeter of the terminal leg.

The slope 22 may be a concave curved surface as shown in FIG. 4. When the terminal leg 21 is connected to a circuit board 40 (see FIG. 6) through soldering, solder 30 tends to climb up the curved slope 22, as shown in FIGS. 5 and 6, and to compress the outmost end of the terminal leg 21 downward, preventing the same from moving upward to separate from the solder 30. That is, the solder 30 climbed up the slope 22 generates an increased force for the terminal leg 21 to flatly bear on a tin liner 41 over the circuit board 40 and keep constant contact with the solder 30 and thereby ensures a reliable electric performance of the connector. In this case, only a small quantity of or even no solder 30 is needed to cover two sides of the terminal leg 21 to obtain good electric performance for the connector. Thus, chances for the solder 30 to overflow sideways are largely reduced. In other words, undesired contact of solder 30 with neighboring terminal legs 21 could be avoided to ensure normal operation of electric circuits on the circuit board 40.

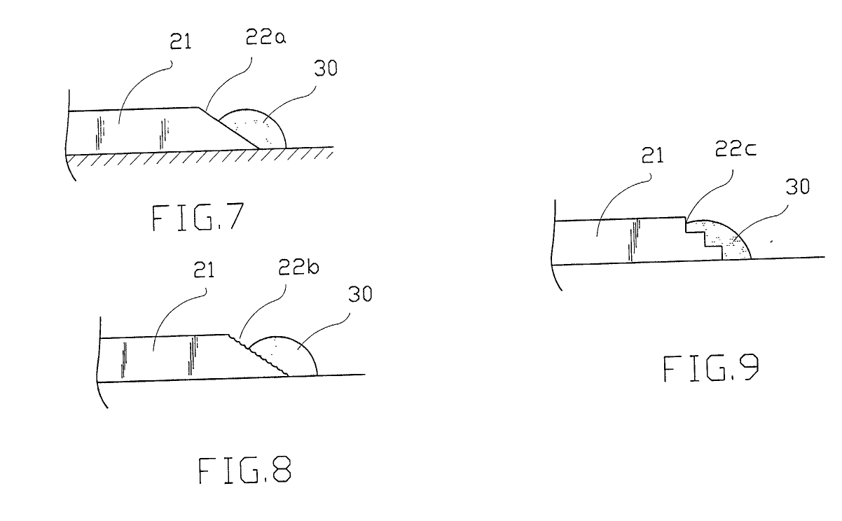

The key point of the present invention is to provide at least one slope 22 on the terminal leg 21, so that solder 30 climbs up the slope 22 to depress the latter and prevent the terminal leg 21 from moving upward to separate from the solder 30. With this principle in mind, many other differently contoured slopes may be designed for the outmost end of the terminal leg 21. FIG. 7 shows a second embodiment of the outmost end of the terminal leg 21 in the form of a downward and outward inclined straight slope 22a, on which solder 30 is applied.

FIG. 8 shows a third embodiment of the outmost end of the terminal leg 21 in the form of a downward and outward inclined serrated slope 22b. The serrated slope 22b enables an enhanced attachment of the solder 30 to the terminal leg 21. FIG. 9 shows a fourth embodiment of the outmost end of the terminal leg 21 in the form of a downward and outward inclined stepped slope 22c. The stepped slope 22c also enables an enhanced attachment of the solder 30 to the terminal leg 21.

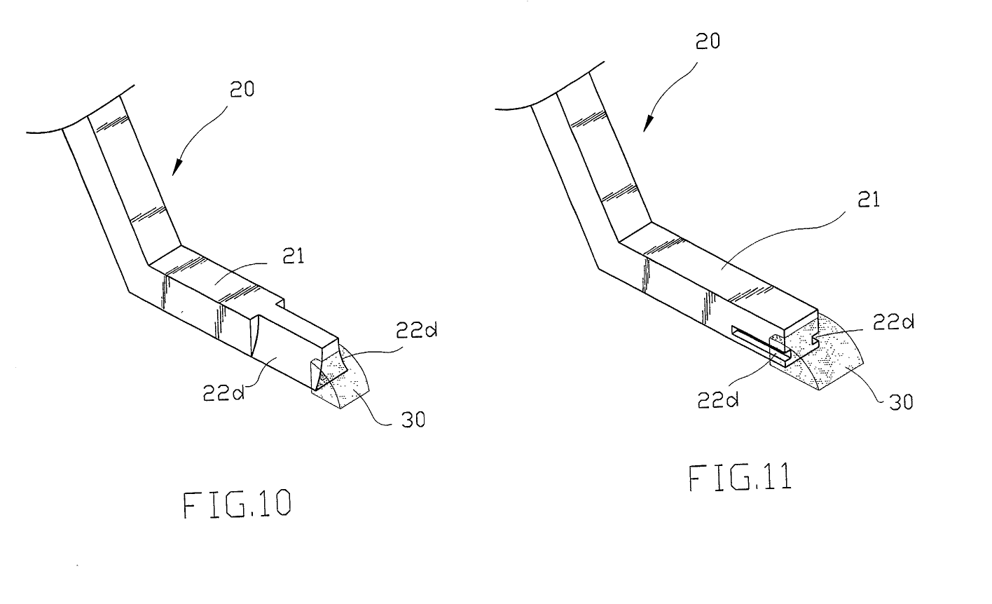

FIG. 10 shows a fifth embodiment of the outmost end of the terminal leg 21. In the fifth embodiment, the terminal leg 21 is provided at two sidewalls adjacent to an end surface thereof with two downward and outward curved slopes 22d. Solder 30 is applied to the end surface of the terminal leg 21 to climb up and wrap the two curved slopes 22d at two sidewalls of the terminal leg 21, generating a downward compression on the outmost end of the terminal leg 21 to prevent the latter from moving upward.

FIG. 11 shows a sixth embodiment of the outmost end of the terminal leg 21. In the sixth embodiment, the terminal leg 21 is provided at two sidewalls adjacent to the end surface thereof with two grooves 22e. Apart of solder 30 applied to the end surface of the terminal leg 21 would flow into the two grooves 22e and generate an increased downward compression force on the two sidewalls to prevent the terminal leg 21 from moving upward and separating from the applied solder 30. Alternatively, the groove may also be directly provided on the end surface of the terminal leg 21. This case is not shown in the drawings.

In brief, the present invention provides a terminal leg, an outmost end of which is so shaped that an effective attachment of solder thereto is ensured to prevent the terminal leg from moving upward and separating from the solder. Moreover, chances of overflowed solder in the course of soldering the terminal leg to the circuit board are largely reduced to ensure good electric performance of the circuits on the circuit board.

What is claimed is:

1. A terminal leg on connector for soldering purpose, comprising an outmost end having at least one slope formed thereat, said slope inclining downward and outward such that a bottom face of said terminal leg forms an outmost perimeter of said terminal leg.

2. The terminal leg on connector for soldering purpose as claimed in claim 1, wherein said slope is provided on an end surface of said outmost end of said terminal leg.

3. The terminal leg on connector for soldering purpose as claimed in claim 1, wherein said slope is provided on both sidewalls of said terminal leg adjacent to said outmost end.

4. The terminal leg on connector for soldering purpose as claimed in claim 1, wherein said slope has a straight top surface.

5. The terminal leg on connector for soldering purpose as claimed in claim 1, wherein said slope has a concave curved top surface.

6. The terminal leg on connector for soldering purpose as claimed in claim 1, wherein said slope has a serrated top surface.

7. The terminal leg on connector for soldering purpose as claimed in claim 1, wherein said slope has a stepped top surface.

8. A terminal leg on connector for soldering purpose, comprising an outmost end having at least one groove provided thereat.

9. The terminal leg on connector for soldering purpose as claimed in claim 8, wherein said at least one groove is provided on both sidewalls of said terminal leg adjacent to said outmost end.

10. The terminal leg on connector for soldering purpose as claimed in claim 8, wherein said at least one groove is provided on an end surface of said outmost end of said terminal leg.

11. The terminal leg on connector for soldering purpose as claimed in claim 8, wherein said at least one groove is provided on an end surface and both sidewalls of said outmost end of said terminal leg.
